(19) United States
(12) Patent Application Publication
(10) Pub. No.: US 2026/0110379 A1
(43) Pub. Date: Apr. 23, 2026

(54) A TUBE CONNECTOR

(71) Applicant: RELIANCE WORLDWIDE CORPORATION (UK) LIMITED, Middlesex (GB)

(72) Inventor: Glen ANSELL, Edgware (GB)

(21) Appl. No.: 19/114,159

(22) PCT Filed: Sep. 27, 2023
(86) PCT No.: PCT/GB2023/052507

§ 371 Date: Mar. 21, 2025

(30) Foreign Application Priority Data
Sep. 30, 2022 (GB) 2214413.3

(51) Int. Cl. F16L 37/091

(52) U.S. Cl. CPC F16L 37/091

(57) ABSTRACT

A tube connector with a body (2) to receive a tube T. A retaining ring (13) grips the tube. An O-ring (10) seals on the tube. The body has at least one window (9) at a position that the fully inserted tube will reach. A see-through insert (6) receives the tube and spans the window and being sealed to an inner face of the body to seal a path to the window. The fully inserted tube T is visible from outside the connector through the window (9) and insert (6). As an alternative the insert (60) may not be see through but is positioned such that the fully inserted tube T is visible through the window (9). The connector may be formed by adapting an existing connector body (2) to provide the window(s) (9).

The present disclosure relates to a tube connector to receive and secure a tube. The connector is primarily designed as a plumbing connector, but may be used in any situation where it is desirable to retain a tube. For example, for an air/gas or cable connector.

The present disclosure is particularly concerned with the idea of incorporating a tube insertion indicator into the connector. The tube insertion indicator allows a user to verify that the tube has been correctly inserted into the connector.

This is particularly difficult to do with an outside diameter (OD) connector. Such a connector is characterised by an ability to seal on the outermost wall of the tube in contrast to an inner diameter (ID) connector which seals on the innermost wall of the tube.

As set out below, the present disclosure can be applied to both types of connectors.

One example of a tube insertion indicator for an OD connector is disclosed in WO 2021/183911. This uses an activation ring which, upon insertion of the tube into the connector is moved into an extended position towards the open end of the connector pushing an annular body in the same direction. The annular body is provided with an indication member which is pushed into alignment with a window in the housing such that the indication member is viewable within the window. The presence of the indication member in the window provides a visual indication to a user that the tube has been fully inserted. JP2008/190587 discloses a similar insert in the form of a scratch proof sleeve.

Although this sleeve is presented as optional there is no description of an example which does not have this sleeve.

Another type of OD connector is shown in WO2020/001029. The main part of the body in the central region of the connector is transparent.

According to the present disclosure, there is provided a tube connector to receive and secure a tube, the connector comprising: a body with a throughway with an open proximal end to receive a tube; a retaining ring to grip, in use, the tube inserted into the connector; a main O-ring seal within the throughway to seal, in use, on the tube inserted into the connector; the body having at least one window at an axial position that the fully inserted tube will reach, in use; a see-through insert retained within the body to receive, in use, the tube inserted into the body, the see-through insert spanning the at least one window and being sealed to an inner face of the body to seal a path from the throughway to the window; wherein the at least one window and insert are positioned such that the fully inserted tube is visible, in use, from outside the connector through the at least one window and insert.

The present disclosure provides a see-through insert spanning a window in the body. When the tube is inserted, it is viewable through the window and insert. This provides a number of benefits over the ring of WO 2021/183911 and the sleeve of JP2008/190587. The tube insertion indicator does not rely on any movable components within the connector. This allows the connector to have a simplified structure as there is no need to accommodate additional moveable components. This allows for a reduced cost and a more compact design.

The design is also fail safe in that, when the tube is in the correct position, it is observed directly. With a design which relies on secondary parts, there is the possibility of a false negative if the tube is correctly inserted but the components have not moved to the correct location. This may occur if one of the components is faulty or is incorrectly fitted. On the other hand, a false positive may be indicated if the components have moved to the location indicating the presence of the tube when, in fact, the tube has not been correctly inserted. This may occur, for example, if the indication member is pushed to the correct position, but the tube is then backed off.

This also provides a degree of confidence for the user in that, if they can see the tube, they know for certain that it has been correctly inserted. This also avoids the potential for confusion as the user does not have to remember which visual indicator represents the presence of the tube and which represents the absence of the tube. They simply have to look for the tube.

The present disclosure is versatile in that it can be applied to many forms of connector. Also, it can use a number of components from an existing connector as all that is required is to provide a see-through insert (often in place of an existing insert) and form one or more windows in the body. This forms a third aspect of the disclosure as discussed below.

It would be possible to make the connector body see-through. However, this is expensive and see-through materials do not generally have the best structural properties. Use of a see-through insert provides a low cost solution to the problem of viewing the tube.

Particularly in an OD connector, the insert can be small which helps to keep the cost low. This provides an advantage over WO2020/001029 where a large proportion of the body is formed of transparent material. In this case there is no potential flow path between the body and transparent part, so that there is no need to provide a seal between the two components.

As mentioned above, the present disclosure is also applicable to an ID connector. One such connector is disclosed in WO 2015/089583. This discloses the idea of a coloured ring which is pushed into a position visible through a slot in the collet. The above issues concerning the use of the secondary indicator component to indicate the presence of the tube apply to this reference.

There are some ID connectors in which part of the housing itself is made of a see-through material. A coloured ring or the end of the tube is pushed into the see-through region of the connector as the tube is inserted.

The transparent material in the prior art has to provide the required toughness and structural integrity of the housing. This places potentially conflicting requirements on the material of the body. This could be solved using a higher grade material, but this adds expense. In the present disclosure, the housing may be made of a conventional material such that the full integrity of the housing is provided in a generally conventional way. As the insert is retained within the housing, it does not need to contribute to the structural integrity of the housing.

The transparent part in the prior art needs to be compatible with the other materials which form the remainder of the housing. In the present disclosure, the insert only needs to be sealed within the housing and therefore does not need to be attached to it as in the prior art where several parts, including the transparent part, must be connected together to form the housing.

Examples of such ID connectors are shown in JP2016/075308, EP1995506, JP2012/219894, CN213871602, EP3608576, EP2246607, and US2009/0295152. JP 2010/007820 discloses a connector with a fully transparent body. In such ID connectors, the seal occurs between the body of the connector and the inner diameter of the tube so that there is no need for a seal between the insert and body.

The requirement for a see-through insert is one which is best understood functionally. Thus, any insert made of a material with sufficient transparency to allow the tube to be viewed through the insert is a suitable insert. The material may be tinted, or have a relatively small degree of light distorting properties (such as a low level of internal cloudiness, or surface distortion such as frosting). Such inserts fall within the claim provided that the tube can be seen through the insert well enough for a user to verify its presence. In practice, the insert should have the highest degree of transparency that is achievable in a material which meets the other requirements of the insert such as cost and structural integrity.

Suitable transparent materials include Polysulphone [PSU] Polyphenylsulphone [PPSU] and some Polyamides [PA6/PA66] and modifed Polyamides [eg EMS Grivory].

The at least one window in the body may be filled with a similar or different see-through material. More simply, the at least one window is a through hole. There may be a single window, or any number of windows may be provided. One possibility is to provide a pair of windows diametrically opposed to one another. These can be formed by drilling through the connector body. This provides a way of creating the body using an existing mould as an existing body can be modified simply by drilling to provide two diametrically opposed windows. One or more additional pairs of windows could be provided.

The sealing between the insert and the body may be provided just to seal a path from the throughway to the window. Alternatively, the insert may be sealed to an inner face of the body on both sides of the at least one window. The seal(s) between the insert and the inner face of the body may, for example, be provided by bonding or welding the insert to the body. However, more simply, an insert O-ring seal is provided on one or both sides of the at least one window to seal the insert to an inner face of the body.

The O-ring seal or each respective O-ring seal which seals between the insert and the inner face of the body, is optionally housed in a groove in the insert. By having the O-ring grooves onto the insert, the bore in the housing can have a single diameter in the region of the insert, such that the body is easier to make as it can readily be moulded and will require fewer steps if it is machined.

The maximum thickness of the wall of the insert is optionally at least 70%, optionally at least 80% and optionally at least 90% of the diameter of the cross section of the main O-ring seal in an uncompressed state. As such, the insert extends radially for a significant proportion of the thickness of the O-ring seal so that the O-ring seal is well supported and is well protected against being dislodged upon insertion of the tube.

The retaining ring may be a collet or a grab ring. The present disclosure can be employed either type of retaining ring and these will operate to selectively retain the tube within the connector. The tube connector may be a single use connector. However, it is intended for use as a multi-use connector, it additionally comprises a release mechanism to release the tube from the retaining ring to allow withdrawal of the tube from the connector.

If the tube connector is to operate as an outer diameter connector, the main O-ring seal is positioned to seal on an outer diameter of the tube inserted, in use, into the connector. The inert may be provided with an outer wall which is sealed to the inner face of the body and an inner wall spaced from the outer wall to define an annular gap to receive the tube, in use. This inner wall is configured to fit within and support the inner wall of the tube.

The inner wall may be provided with an inner diameter O-ring seal on its outer face to seal, in use, with the inner diameter of the tube. If the connector is an inner diameter connector only, then this inner diameter O-ring seal provides the main O-ring seal referred to above. Alternatively, if the connector is configured to seal on both the inner diameter and outer diameter of the tube, then the main O-ring seal is positioned to seal on the outer diameter of the tube and the inner diameter O-ring seal provides a second seal with the inner diameter of the tube.

According to a second aspect of the disclosure, there is provided a tube connector to receive and secure a tube, the connector comprising: an opaque outer body with a throughway with an open proximal end to receive a tube; a retaining ring within the throughway to grip, in use, the tube inserted into the connector; a main O-ring seal within the throughway to seal, in use, on the tube inserted into the connector; the body having at least one window in a sidewall at an axial position that the fully inserted tube will reach, in use; an insert to receive the tube, in use, and being sealed to an inner face of the body to seal a path from the throughway to the window; wherein the at least one window is positioned such that the fully inserted tube is visible, in use, from outside the connector through sidewall of the body through the at least one window.

As compared to WO 2021/183911, this connector allows direct viewing of the tube as rather than viewing a secondary component. This provides the advantages above.

Other connectors, for example, as disclosed in WO2022/018412 and WO2022/018413 allow direct visibility of the tube in the fully inserted position. However, the tube is viewed through an opening in the end of the collet, not the side wall of an outer body. As such, it is harder to see the fully inserted tube in the locked connector as it can only be seen, in the locked position, from a limited angle.

The insert may receive the tube internally and/or externally.

The at least one window may be a through hole. There may a pair of windows diametrically opposite one another.

The insert may be the see-through insert described above, and all of the above described features may be provided in the second aspect of the disclosure. The insert may be retained within the body. Alternatively, the insert is insertable with the tube. In this case, the insert may have an O-ring to seal with the inner diameter of the tube.

Any part of the insert which is not within the tube may be distal of the at least one window when the tube is fully inserted into the connector. If the insert is not see through, this allows the tube to be viewed through the window when the tube is fully inserted. This configuration may optionally be used if the insert is see-through.

According to a third aspect of the disclosure there is provided a method of adapting an existing connector body to form a tube connector according to the first or second aspects, the method comprising forming at least one hole in an existing connector body to create the window and inserting the insert into the connector body such that the insert seals off a potential flow path between the throughway and the hole.

This allows the connector to be implemented across a wide variety of existing connectors without expensive new tooling being required for multiple new components such as bodies, caps, collets or grab rings.

If the body is moulded, the hole may be formed by adapting an existing mould body to create the hole as part of the moulding process which would require some adaptation of the mould, or by forming the hole as a subsequent step after the body has been moulded which would allow and existing mould to be used, but requires a separate step, of, for example, drilling.

Examples of connectors in accordance with the present disclosure will now be described with reference to the accompanying drawings, in which:

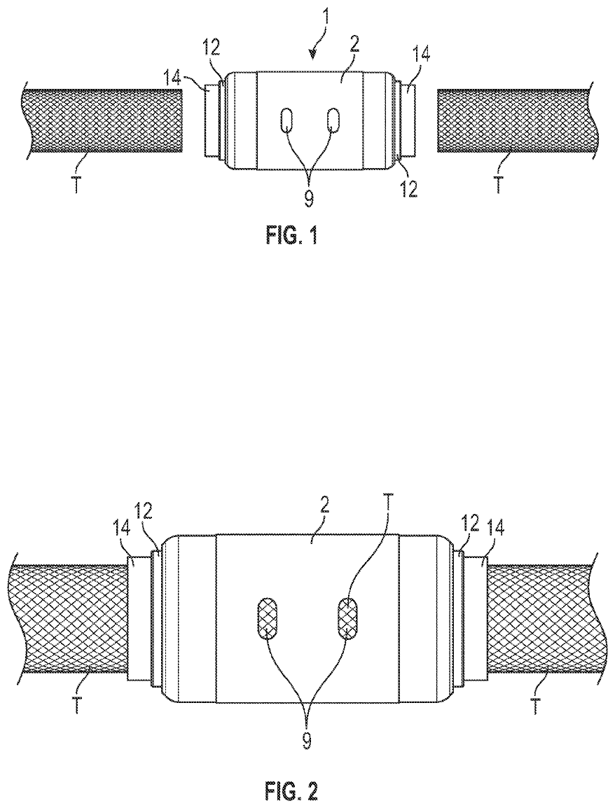

FIG. 1 is a plan view of a first connector and two tubes prior to connection;

FIG. 2 is a view similar to FIG. 1 with the tubes connected;

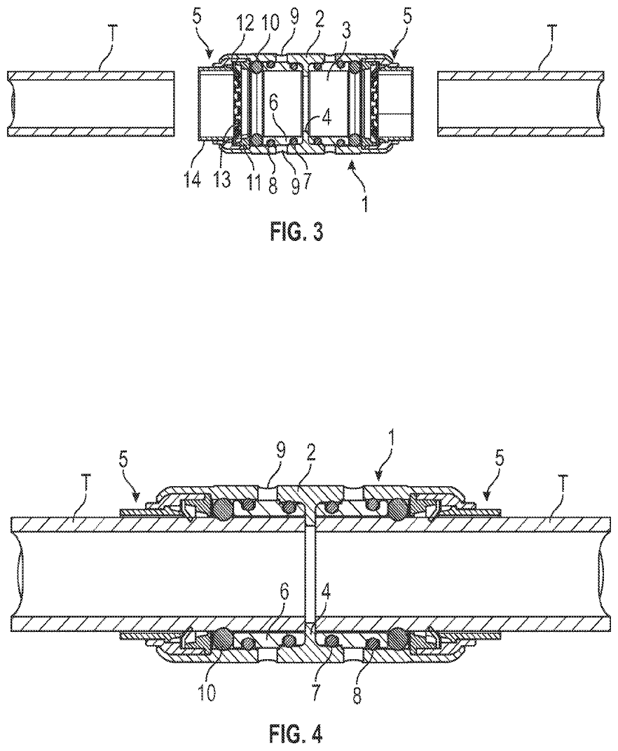

FIG. 3 is a cross-sectional view of the first connector and the tubes in the configuration shown in FIG. 1 and including a first insert;

FIG. 4 is a view similar to FIG. 3 with the tubes connected;

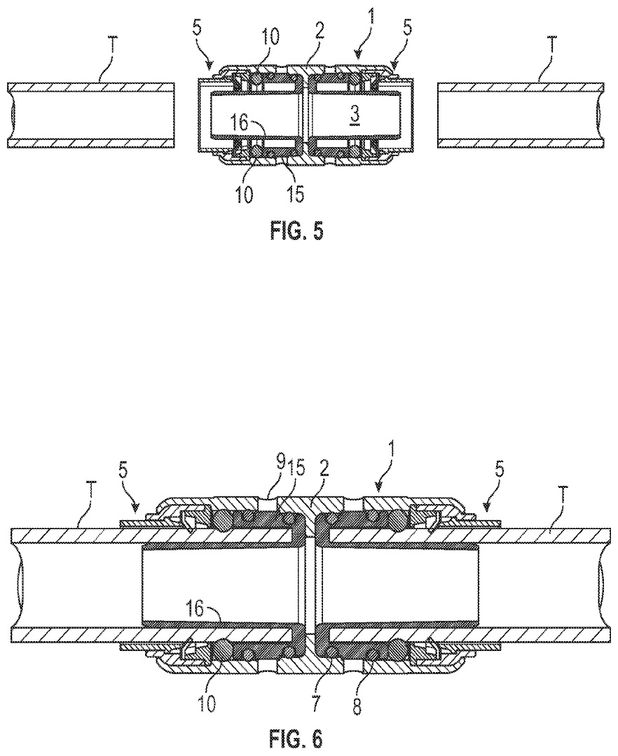

FIGS. 5 and 6 are views similar to FIGS. 3 and 4 showing the first connector with a second insert;

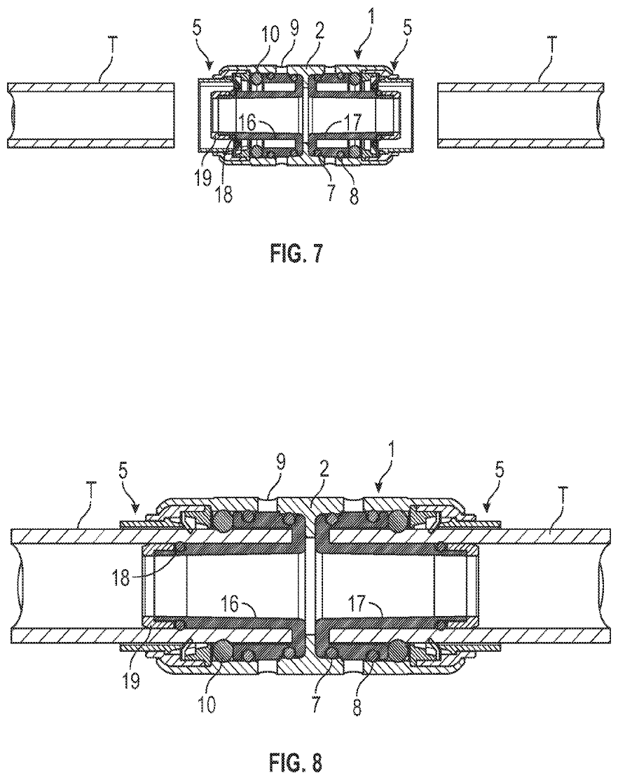

FIGS. 7 and 8 are views similar to FIGS. 3 and 4 showing the first connector with a third insert;

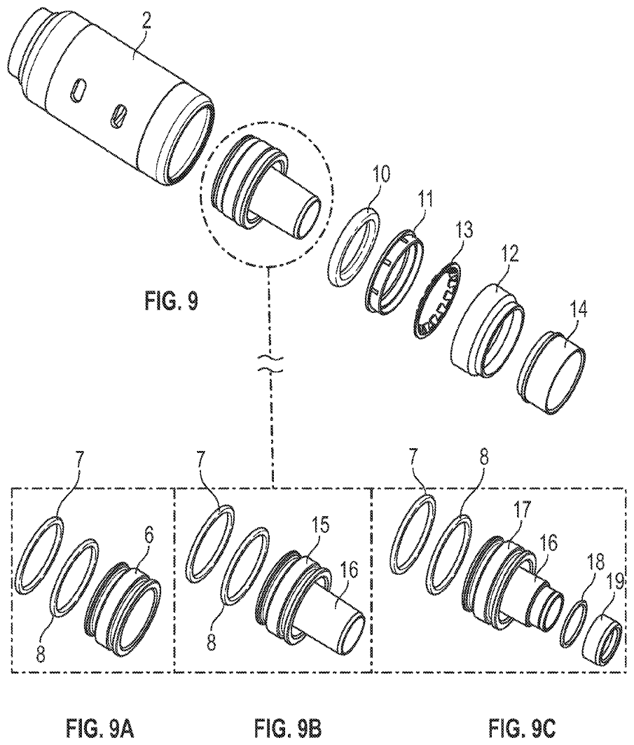

FIG. 9 is an exploded perspective view of the first connector with FIGS. 9A-9C providing alternative exploded perspective views of the first to third inserts respectively;

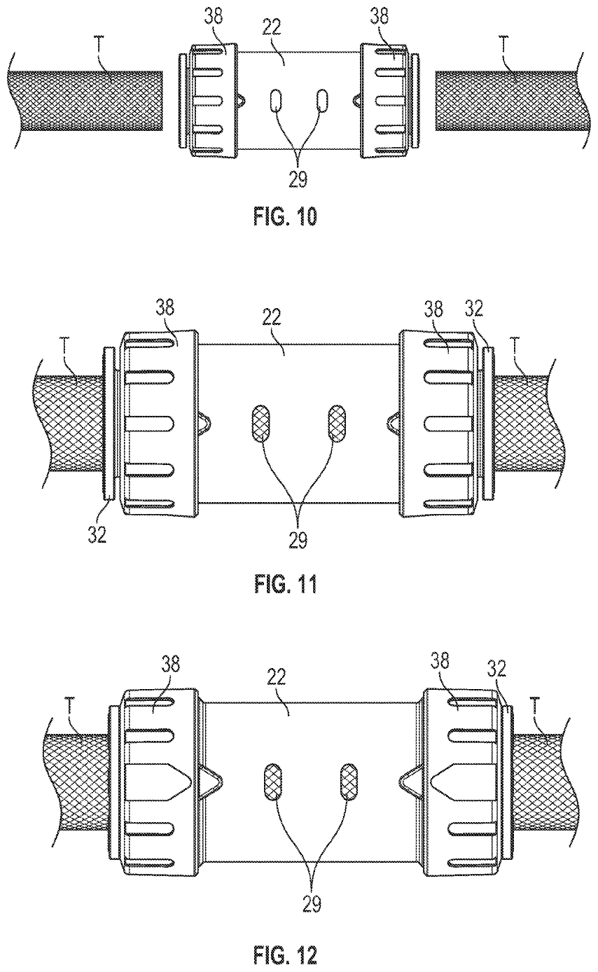

FIG. 10 is a plan view similar to FIG. 1 showing a second connector and two tubes;

FIG. 11 is a view similar to FIG. 10 with the tubes inserted into the second connector which is in an unlocked configuration;

FIG. 12 is a view similar to FIG. 11 with the connector locked;

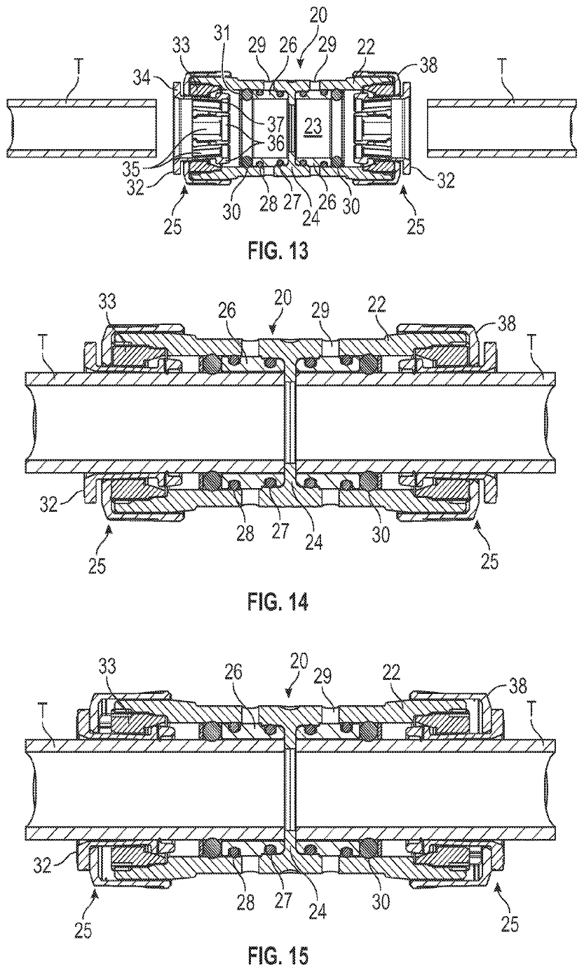

FIG. 13 is a cross-sectional view of the second connector and tubes in the configuration shown in FIG. 10 and including a first insert;

FIG. 14 is a view similar to FIG. 13 with the tubes fully inserted;

FIG. 15 is a view similar to FIG. 14 with the connector locked;

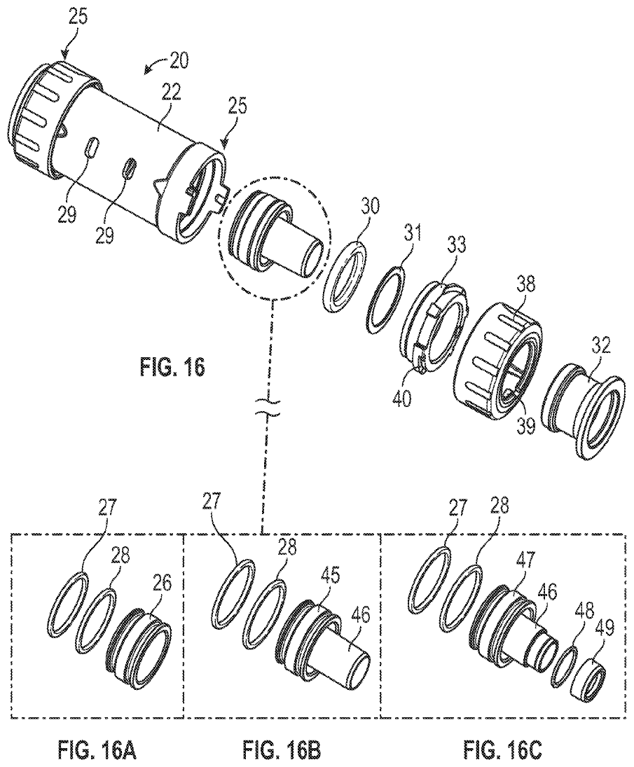

FIG. 16 is an exploded perspective view similar to FIG. 9 of the second connector with FIGS. 16A-16C providing alternative exploded perspective views of the first to third inserts respectively;

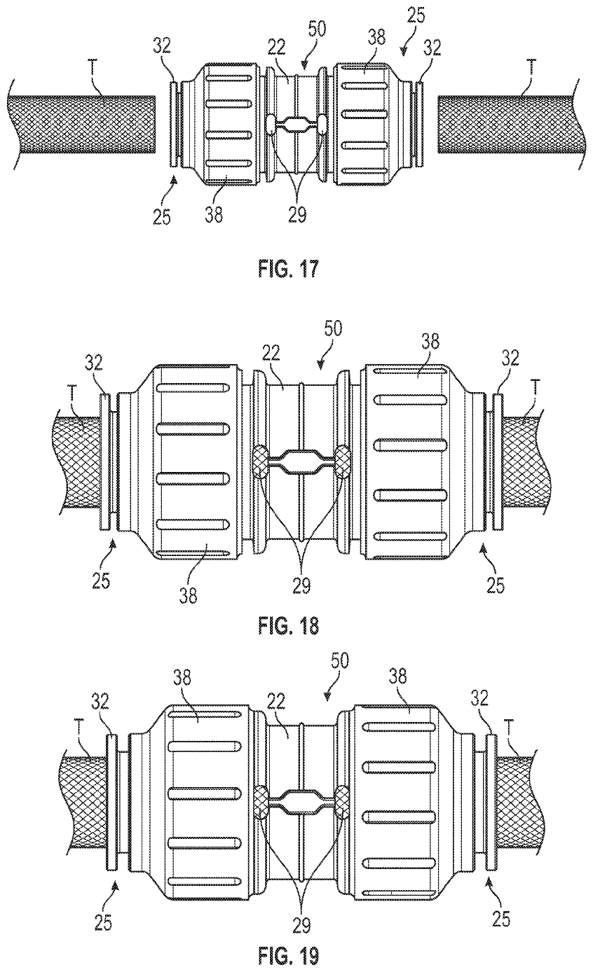

FIG. 17 is a plan view similar to FIG. 1 showing a third connector and two tubes;

FIG. 18 is a view similar to FIG. 17 with the tubes inserted into the third connector which is in an unlocked configuration;

FIG. 19 is a view similar to FIG. 18 with the connectors locked;

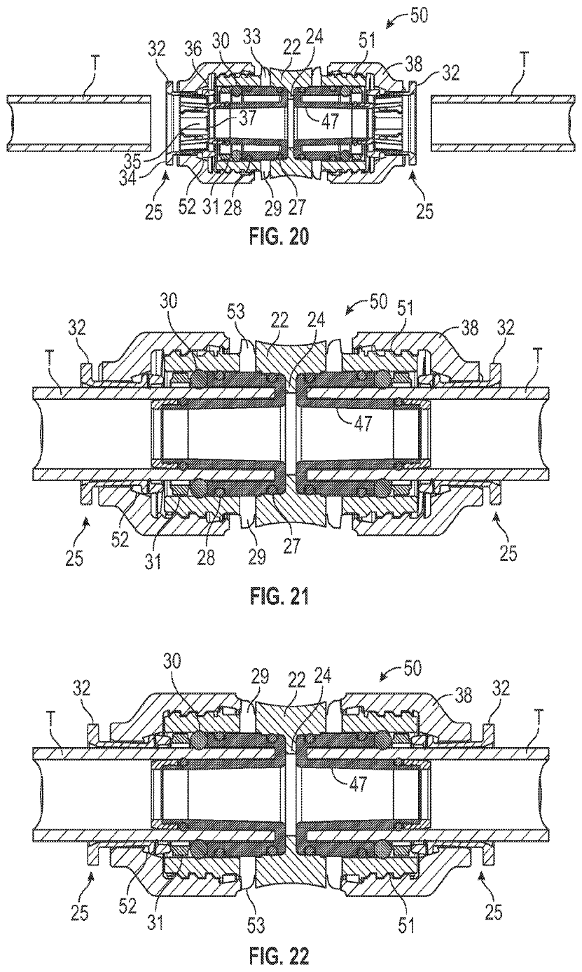

FIG. 20 is a cross-sectional view of the third connector and the tubes in the configuration shown in FIG. 1 and including a third insert;

FIG. 21 is a view similar to FIG. 20 with the tubes fully inserted as in FIG. 18;

FIG. 22 is a view similar to FIG. 21 with the connector locked as in FIG. 19;

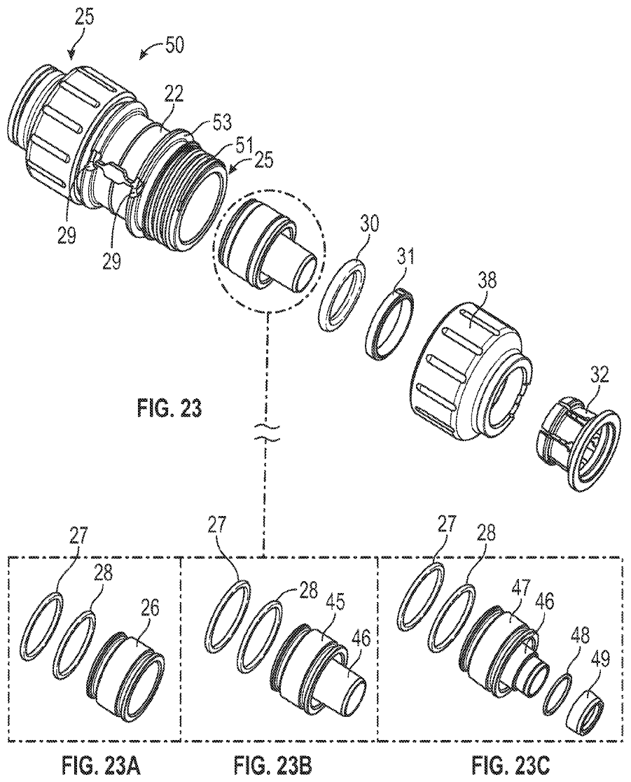

FIG. 23 is an exploded perspective view similar to FIG. 9 of the third connector with FIGS. 23A-23C providing alternative exploded perspective views of the first to third inserts respectively;

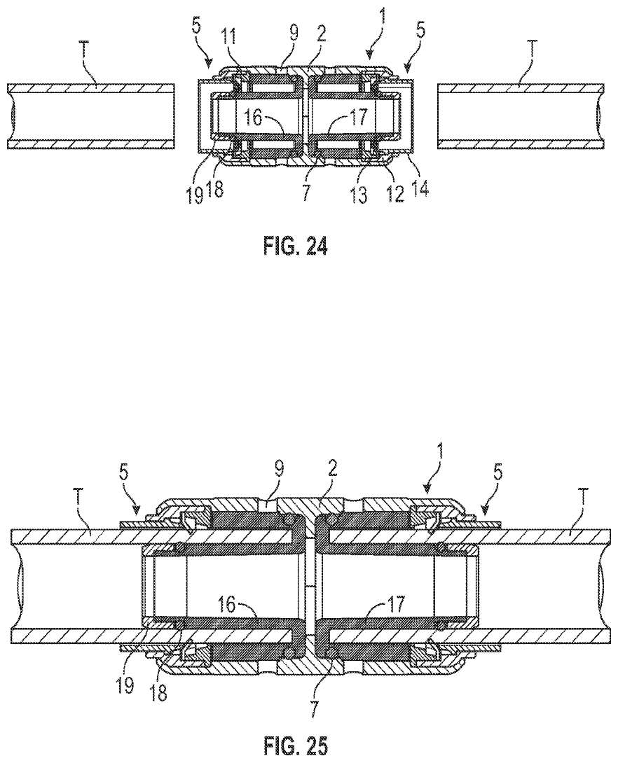

FIGS. 24 and 25 show the first connector with a variation of third insert of FIGS. 7 and 8;

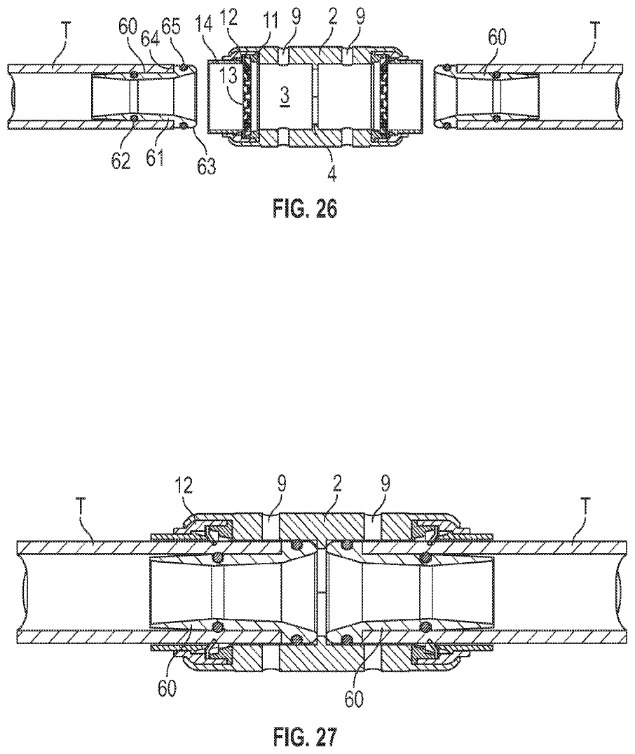

FIG. 26 is a cross section of an example of the second aspect of the disclosure comprising the first connector and two tubes with a fourth insert prior to connection;

FIG. 27 is a view similar to FIG. 26 with the tubes connected;

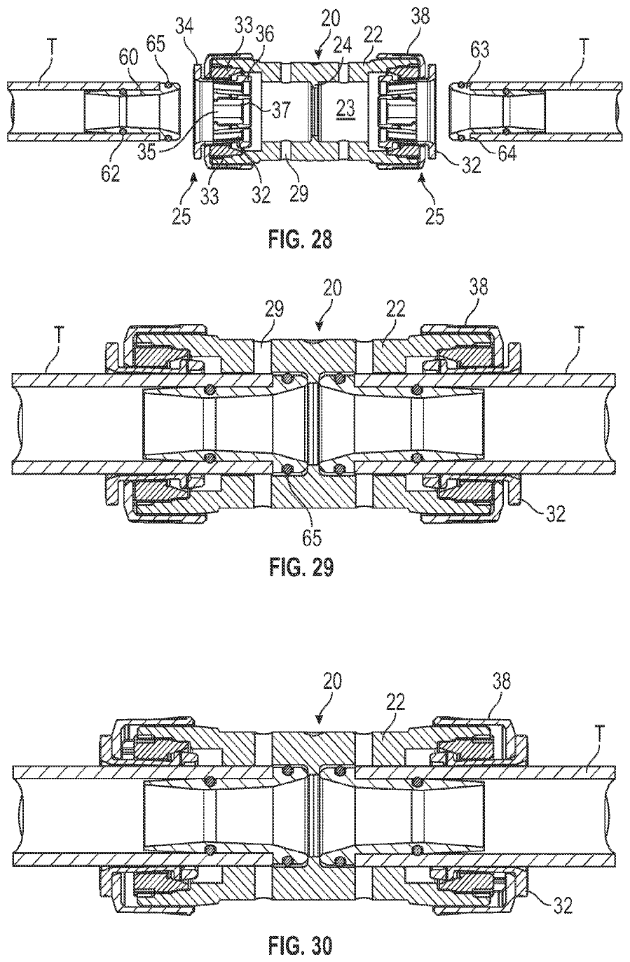

FIG. 28 is a cross section of an example of the second aspect of the disclosure comprising the second connector and two tubes with the fourth insert prior to connection;

FIG. 29 is a view similar to FIG. 28 with the tubes connected;

FIG. 30 is a view similar to FIG. 29 with the connector locked;

FIG. 31 is a cross section of an example of the second aspect of the disclosure comprising the third connector and two tubes with a variation of the fourth insert prior to connection;

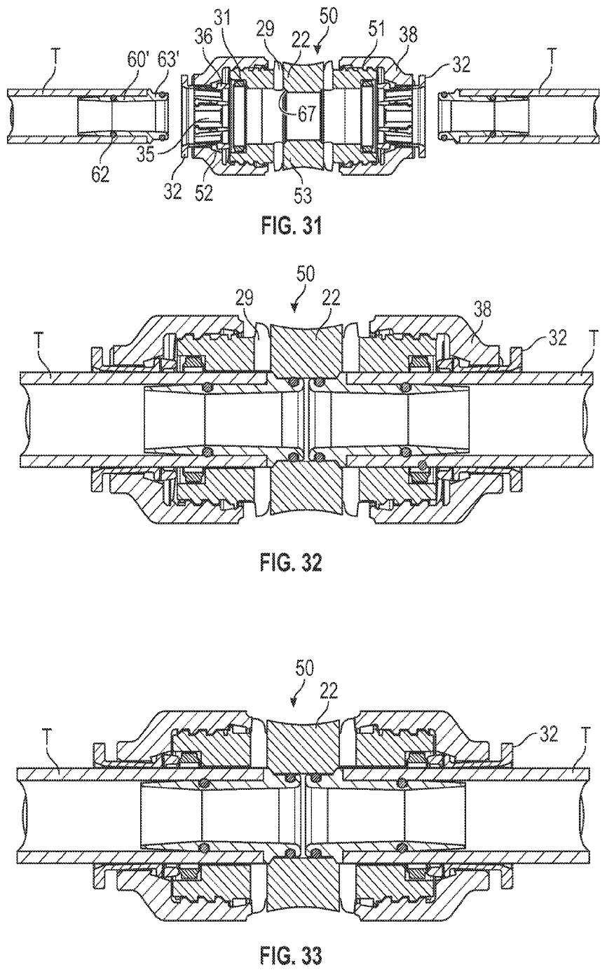

FIG. 32 is a view similar to FIG. 31 with the tubes connected; and

FIG. 33 is a view similar to FIG. 32 with the connector locked.

The specification references proximal and distal ends and directions. The proximal end is the open end of the connector and the distal end is the end furthest from the open end. In the case of the double ended connectors illustrated in the drawings, this is the centre of the double ended configuration. The proximal direction is the direction from the distal end towards the proximal end, i.e. out of the connector. The distal direction is the direction from the proximal end towards the distal end, i.e. into the connector.

The drawings show double ended connectors. The description below describes one end of the connector. The other end is the same as the end described and an is not described separately.

All of the drawings show double-ended connectors with a linear configuration. In the broadest sense, only one end may be provided with the connector as described, the opposite end may have a different arrangement. As an alternative to the linear connector, the connector may include an elbow, tee, end stop or manifold with branches or any other suitable shape of fitting configuration. As an alternative, the connector may be part of a larger component or other plumbing installation or apparatus and provide a means to connect this to a tube.

A first connector will now be described with reference to FIGS. 1 to 9. This first connector is provided with three alternative inserts as will be described. The basic form of the connector is based on our Sharkbite (RTM) Connector.

The first connector 1 comprises a body 2 with an axial through bore 3. In the connector on which this design is based, the body is brass, and this may be used in the present example. Alternatively, the main body may be made of a plastics material. The two halves of the connector are separated by an annular flange 4 to support an end of the tube T.

A number of components are then inserted from the open end 5 of the connector. A see-though insert 6 has a hollow or tubular structure and is provided with a distal 7 and proximal 8 insert O-rings. The insert 6 lands on the flange 4 such that the insert O-rings 7,8 are positioned on opposite sides of through holes 9 in the wall of the body 2 and seal with the inner wall of the body 2.

A main O-ring 10 is supported by the proximal end of the insert 6.

The proximal end of the O-ring 10 is supported by a support ring 11. A support sleeve 12 is fitted over the support ring 11 and supports a grab ring 13. A release sleeve 14 projects from the open end 5 proximally from the support sleeve 12.

Once assembled, the tubes T can be inserted into the connector 1 as shown in FIG. 4. The tube T is inserted until it is stopped by the flange 4. At this point, it is held in place by the grab ring 13. The presence of the tube T is visible through the through holes 9 and the insert 6 as illustrated in FIG. 2.

Liquid passing through the connector can pass from the end of the tube T between the outer wall of the tube T and the insert 6. This is then sealed by the main O-ring 10 T

he distal insert O-ring 7 provides a seal between the body 2 and the distal end of the insert 6. The main O-ring 10 can be configured to seal the distal end of the junction between the body 2 and insert 6. In practice, however, this seal is optimised to seal with the tube T and will be distorted by the tube. Therefore, the proximal insert O-ring 8 is provided to reliably seal the proximal end of the insert 6 to the housing 2.

In order to remove the tube, the release sleeve 14 is depressed inwardly thereby deflecting the teeth of the grab ring 13 radially outwardly and holding them away from the wall of the tube T allowing the tube T to be removed. The release sleeve 14 may be omitted for a single use connector.

In order to adapt an existing connector, it is simply a matter of forming the through holes 9 in a wall of the housing. This can be done by forming the holes in a drilling step. The insert 6 with O-rings 7, 8 can then substitute for a conventional non-see-through insert. Thus, the connector can largely be made from conventional components and can be sold as part of an existing range of connectors as a modified version with a tube insertion indicator capability.

FIGS. 5 and 6 show the first connector 1 in the same way that it is shown in FIGS. 3 and 4, the only difference being that the second connector 1 is fitted with a second insert 15. This second insert 15 is also illustrated in FIG. 9 and FIG. 9B. The second insert 15 has all of the features of the first insert 6 including the distal and proximal insert O-rings 7,8 and fits within the body 2 in the same way.

The only difference is that the second insert 15 has a tube support 16 in the form of an annular wall which extends proximally from the distal end of the insert and is inwardly spaced from the outer part of the insert 15 creating an annular space into which the tube T is fitted. As can be seen in FIG. 6, this supports the inner wall of the tube T in the connector 1 thereby ensuring that the tube T retains a well-defined geometry in this region.

FIGS. 7 and 8 show the first connector 1 with a third insert 17. This is also shown in FIG. 9C. The third insert 17 is similar to the second insert 15 in that it also has a tube support 16. However, the third insert 17 comprises an ID O-ring 18 on its outer face which will seal on the inner diameter of the tube T as shown in FIG. 8. The tube support 16 has an end cap 19 fitted over and attached to the tube support 16 in order to provide groove for the O-ring 18. This is done as the shape of the third insert 17 is difficult to mould as a single piece. However, this could be moulded as a single piece using a more complex mould, or could be moulded in the same manner as the second insert 15 and the O-ring groove can then be cut.

As shown in FIG. 8, the third insert 17 provides both an ID and an OD seal in that the O-ring 10 seals on the outer diameter of the tube T and the ID O-ring 18 seals on the inner diameter of the tube T. Certain countries have an opacity test for any component of a connector which provides a direct light path into a region which may contain liquid. This design meets these requirements by ensuring that no water can be present in the region directly behind the window. Alternatively. as the ID O-ring 18 seals the leakage path between the tube support 16 and the tube T, in some circumstances, the O-ring 10 can be omitted such that the connector becomes an ID connector only.

The connector is therefore very versatile in that, the user simply chooses one of the interchangeable inserts depending on their requirements, namely whether they require on ID and/or OD seal and whether they require a tube support. These requirements can all be satisfied just by changing the insert, while the majority of the connector remains the same. This has benefits in terms of reduced inventory and tooling costs.

A second connector 20 is shown in FIGS. 10 to 16. The second connector 20 is based on our ProLock (RTM) Connector. Like the first connector, the second connector may also have three alternative inserts as described below.

The second connector 20 comprises a body 22 with an axial through bore 23. An annular central flange 24 projects into the through bore 23. The connector 20 has an open end 25 at each end via which a respective tube T can be inserted as far as the flange 24.

A first insert 26 is inserted into the through bore 23 from an open end 25 and lands on the flange 24. The first insert 26 of the second connector 20 has essentially the same structure as the first insert 6 of the first connector 1. In particular, the first insert 26 is made of a see-through material and is provided with the distal insert O-ring 27 and a proximal insert O-ring 28.

As with the first example, the body 22 is provided with a pair of though holes 29 in alignment with a part of the insert 26 between the O-rings 27, 28 allowing the presence of a tube T fully inserted in the connector to be seen from outside the connector via the through holes 29 and insert 26.

A main O-ring 30 is supported on the proximal end of the insert 26 and seals with the outer diameter of the tube T as seen in FIGS. 14 and 15. An O-ring support ring 31 supports the proximal end of the main O-ring 30.

The features described thus far are essentially the same as those of the first connector 1.

The main difference is that, while the first connector uses a grab ring 13 in order to retain the tube, the second connector 20 uses a collet 32. This is retained within the body 22 by an end cap 33.

The collet 32 has a conventional structure with a collet ring 34 protruding from the open end 25 of the connector. A plurality of resilient legs 35 extend distally from the O-ring 34 and each terminate in a collet head 36 provided with a respective tooth 37 which interact with a cap angle on the end cap 33 to grip the tube T, in use.

A locking ring 38 is rotatably retained on the open end 35 of the second connector 20. The locking ring 38 is provided with a cam 39 which is complementary with a cam groove 40 and the end cap 33. This allows the locking ring 38 to be rotated between an unlocked position in FIG. 14 to a locked position shown in FIG. 15. In the unlocked position, the collet 32 is axially movable such that it can be pressed distally into the connector to hold the collet teeth 37 away from the tube T thereby allowing withdrawal of the tube T. In the locked position shown in FIG. 15, the relative position of the cam 39 on the cam groove 40 ensures that the collet 32 is no longer axially movable such that it is not possible to depress the collet 32 inwardly with the locking ring 38 in this position. The locking ring 38 has to be rotated to the unlocked position shown in FIG. 14 to allow the collet 32 to be depressed and the tube T to be released.

As an alternative to the first insert 26, the second connector 20 can be provided with a second insert 45 as shown in FIG. 16B. This is essentially the same as the second insert as described in relation to the first example in that it is provided with a tube support 46 which supports the inner face of the tube T in the same way as described in relation to the second insert 15 in the first example.

Similarly, the second connector 20 may have a third insert 47 as shown in FIG. 16C. This is essentially the same as the third insert 17 described in relation to the first example and has the same ID O-ring 48 and end cap 49.

A third connector is shown in FIGS. 17 to 23. This has many features in common with the second example and the same reference numerals have been used to designate the same features. As with the previous two examples, three alternative interchangeable inserts 26, 45 and 47 are contemplated as shown in FIGS. 23A to 23C. FIGS. 20 to 22 show the connector with the third insert 47.

The third connector 50 is based on our Speedfit (RTM) Connector. As with the second example, the third connector 50 also uses a collet 32 to grip the tube T. In this case, the locking ring 38 is attached to the body 22 by complementary screw threads 51 allowing the locking ring 38 to be moved between an unlocked position shown in FIG. 21 and a locked position shown in FIG. 22. The O-ring support 31 is longer in the axial dimension as compared to the second connector. Further, the locking ring 38 is provided with the cap angle 52 whereas, in the first example, it is provided on the end cap 33. The body 22 has a more complex shape in that it has an annular flange 53 to provide an end stop for the locking cap 38. The through holes 29 are shown formed through the flange 53 although they could be offset from this flange if the spacing of components is slightly different.

With the connector 50 in the unlocked position shown in FIG. 21, the tube T is inserted. The locking ring 38 is then rotated to the locked position shown in FIG. 22 in which it lands on flange 53. Alternatively, the connector 50 may be configured such that the tube T can be inserted even if the locking ring 38 is in the locked position. In this position, axial movement of collet 23 is prevented by the locking ring 38. As previously, the presence of the tube T in the fully inserted position, can be verified by the user as it is visible through the through holes 29 and respective see-through inserts 26, 45, 47.

FIGS. 24 and 25 show a variation of the first connector 1 with a third insert 17 shown in FIGS. 7 and 8. As shown in FIGS. 24 and 25, the O-ring 7 seals the leak path around the connector, while the O-ring 18 seals the inner diameter of the tube. The O-rings 8 and 10 (in FIGS. 7 and 8) are not necessary in certain circumstances and have been omitted in FIGS. 24 and 25. As a further alternative one of O-rings 8 or 10 can be included without the other.

The second and third connectors 20, 50 are described with a locking ring. This feature can be omitted if there is no need to lock the collet in place.

The above description demonstrates the versatility of the present disclosure. The see-through inserts can be provided in various different types of connector. The geometries of the inserts may be identical such that they are interchangeable between connectors or minor changes in geometry may be made in order to fit within the respected bodies. The connector can either be manufactured as an entirely new type of connector or can take advantage of existing components simply by replacing an existing insert with a see-through insert as described above and forming one or more through holes in the connector body.

FIGS. 26 to 33 are examples of the second aspect of the disclosure. FIGS. 26 and 27 show the first connector, FIGS. 28 to 30 show the second connector and FIGS. 31 to 33 show the third connector. These are shown with a fourth insert 60 as described. Certain modifications have also been made to the connectors in order to accommodate the new insert, but the reference numerals from the earlier examples have been used to designate similar components and the differences with the connector configurations are described below in addition to the description of the new insert.

The most significant differences are that the fourth insert 60 is attached to the tube T prior to being inserted in the connector, and that the fourth insert 60 does not need to be made of a see-through material.

With reference to FIGS. 26 and 27, the insert 60 has a generally cylindrical hollow configuration with a narrower insertion portion 61 which has an O-ring 62 such that, when the insertion portion 61 is inserted in the tube T, the O-ring 62 seals with the inner diameter of the tube T.

The insert 60 has an enlarged head 63 with an outer diameter which matches the outer diameter of the tube T. The head 63 defines a shoulder 64 which provides an end stop for the end of the tube T. An O-ring seal 65 surrounds the head 63 to seal within the connector as described below.

As compared to the first connector derived in FIGS. 1-9, the body 2 has a thicker wall. This is because the diameter of the insert 60 is the same as the outer diameter of the tube T, whereas, in the previous examples, the insert surrounds the tube T. Otherwise, the structure of the connector in terms of the sleeve 12, grab ring 13 and release sleeve 14 are as previously described.

In order to make up the connection, the insert 60 inserted into the end of the tube T as shown in FIG. 26. Once this is done, the combination of the tube T and insert 60 are inserted into the connector 2 until the end of the insert 60 is stopped by the flange 4. In this position, the O-ring 65 provides a seal between the through bore 3 and the housing 2. The through holes 9 are positioned at an axial location which is far enough from the flange 4 that they are proximal of the head 63 in the fully inserted position such that the wall of the tube T is visible through the through holes 9.

Thus, as compared to the previous examples in which the tube T was surrounded by a transparent insert aligned with the window to allow the tube to be viewed, in the present example, the inserted is configured such that it does not surround the outer wall of the tube T such that the tube can be visible directly through the window. As there is no need to see through the insert 60, there is no need for the insert 60 to be made of a see-through material (although there is no technical reason why it should not be).

The insert 60 may be specially designed for the purpose, or may be a component which is known in the art. This allows for the connector to be made by adapting existing components simply by the provision of the holds 9 which can be formed in a post-moulding step, for example by drilling. As such, the connector can be made as an adaptation of an existing connector without the need to create new moulds.

The example shown in FIGS. 28-30 shows the second connector of FIGS. 10-16 in combination with the fourth insert 60 which is as described above.

As with the example of FIGS. 26 and 27, the wall of the housing 22 is thicker than in the examples of FIGS. 10 to 16 again reflecting the fact that the insert 60 is no wider than the tube T.

As is apparent from FIGS. 28-30, the insert 60 is inserted into the end of the tube T prior to being inserted into the connector 20 until the insert 60 abuts against the flange 26 as shown in FIG. 29. In this position, the tube T is visible through the window 29 and the seal 65 seals the leak path between the body 22 and the through bore 23. The connector can then be locked as shown in FIG. 30 in the same manner as described with reference to FIG. 15.

The example in FIGS. 31 to 33 shows the third connector of FIGS. 17 to 23 together with a modified version of the fourth insert 60′.

As with the previous examples, the thickness of the wall of the body 22 has been increased view of the different insert configuration. The insert 60′ has a narrower head 63′ than in the previous examples. This is because the insert 60′ is configured to seat on an internal shoulder 67 rather than on a central flange as in the previous examples. The example could alternatively or additionally have a central flange which accommodates the unmodified insert 60 if necessary.

As before, the insert 60′ is inserted into the end of the tube T to seal this inner diameter. It then inserted into the connector 50 until the head 63′ lands on the shoulder 67 such that the seal 65 seals with the body 22 and the tube T is visible through holes 29 in the flange 53.

1. A tube connector to receive and secure a tube, the connector comprising:
a body with a throughway with an open proximal end to receive a tube;
a retaining ring within the throughway to grip, in use, the tube inserted into the connector;
a main O-ring seal to seal, in use, on the tube inserted into the connector;
the body having at least one window at an axial position that the fully inserted tube will reach, in use;
a see-through insert retained within the body to receive, in use, the tube inserted into the body, the see-through insert spanning the at least one window and being sealed to an inner face of the body to seal a path from the throughway to the window;
wherein the at least one window and insert are positioned such that the fully inserted tube is visible, in use, from outside the connector through the at least one window and insert.

2. A tube connector according to claim 1, wherein the at least one window is a through hole.

3. A tube connector according to claim 1, wherein there is a pair of windows diametrically opposite one another.

4. A tube connector according to claim 1, wherein the insert is sealed to an inner face of the body on both sides of the at least one window.

5. A tube connector according to claim 1, wherein the insert is sealed to an inner face of the body on one side of the at least one window by an insert O-ring seal.

6. A tube connector according to claim 5, wherein the O-ring seal is housed in a groove in the insert.

7. A tube connector according to claim 5, wherein the insert is sealed to an inner face of the body on one both sides of the at least one window by a respective insert O-ring seal on each side of the window.

8. A tube connector according to claim 7, wherein the respective O-ring seals are each housed in respective grooves in the insert.

9. A tube connector according to claim 1, wherein the maximum thickness of the wall of the insert is at least 70%, optionally at least 80% and optionally at least 90% of the diameter of the cross section of the main O-ring seal in an uncompressed state.

10. A tube connector according to claim 1, wherein the retaining ring is a collet.

11. A tube connector according to claim 1, wherein the retaining ring is a grab ring.

12. A tube connector according to claim 1, further comprising a release mechanism to release the tube from the retaining ring to allow withdrawal of the tube from the connector.

13. A tube connector according to claim 1, wherein the main O-ring seal is positioned to seal on an outer diameter of the tube inserted, in use, into the connector.

14. A tube connector according to claim 1, wherein the insert has an outer wall which is sealed to the inner face of the body and an inner wall spaced from the outer wall to define an annular gap to receive the tube, in use.

15. A tube connector according to claim 14, wherein the inner wall has an inner diameter O-ring seal on its outer face to seal, in use, with the inner diameter of the tube.

16. A tube connector according to claim 15, wherein the inner diameter O-ring seal is the main O-ring seal.

17. A tube connector according to claim 15, wherein the inner diameter O-ring seal is provided in addition to the main O-ring seal.

18. A tube connector to receive and secure a tube, the connector comprising:
an opaque outer body with a throughway with an open proximal end to receive a tube;
a retaining ring within the throughway to grip, in use, the tube inserted into the connector;
a main O-ring seal within the throughway to seal, in use, on the tube inserted into the connector;
the body having at least one window in a sidewall at an axial position that the fully inserted tube will reach, in use;
an insert to receive the tube, in use, and being sealed to an inner face of the body to seal a path from the throughway to the window;
wherein the at least one window is positioned such that the fully inserted tube is visible, in use, from outside the connector through sidewall of the body through the at least one window.

19. A tube connector according to claim 18, wherein the at least one window is a through hole.

20. A tube connector according to claim 18, wherein there is a pair of windows diametrically opposite one another.

21. A tube connector according to claim 18, wherein the insert is insertable with the tube.

22. A tube connector according to claim 21, wherein the insert has an O-ring to seal with the inner diameter of the tube.

23. A tube connector according to claim 18, wherein any part of the insert which is not within the tube is distal of the at least one window when the tube is fully inserted into the connector.

24. A method of adapting an existing connector body to form a tube connector according to claim 1, the method comprising forming at least one hole in an existing connector body to create the window and inserting the insert into the connector body such that the insert seals off a potential flow path between the throughway and the hole.
